(19) United States
(12) Patent Application Publication
(10) Pub. No.: US 2020/0294161 A1
(43) Pub. Date: Sep. 17, 2020

(54) System and method for sharing dinner tables

(71) Applicant: Shaobo Kuang, Lansdale, PA (US)

(72) Inventor: Shaobo Kuang, Lansdale, PA (US)

(21) Appl. No.: 16/352,810

(22) Filed: Mar. 13, 2019

(51) Int. Cl. G06Q 50/12; G06Q 10/02; G06Q 20/14

(52) U.S. Cl. CPC G06Q 50/12; G06Q 20/14; G06Q 10/02

(57) ABSTRACT

A meal table sharing system according to the present invention comprises a sharing mode unit for allowing a user to select one or many sharing modes; a restaurant selecting unit; a table size unit for allowing the user to select a meal table size or the number of people for the meal; an invitation unit for allowing the user to propose a meal sharing invitation based on the selected restaurant, date, time, sharing mode; a dispatching unit for dispatching the invitation to guests; an accept unit for allowing the guests to accept the invitation; and a confirmation unit for, based on the acceptance by the guests, making a reservation to hold a table at the restaurant, and sending a confirmation to the user and the guests.

### FIELD OF THE INVENTION

The present invention relates to systems and methods for sharing meal tables in restaurants, more particularly to systems and methods for allowing people to find guests to share restaurants' tables for dinner, lunches, suppers or breakfasts.

### BACKGROUND OF THE INVENTION

With the developing of Internet technology, social networks have become increasingly popular. However, most social networks, like FACEBOOK, or WECHAT, allow people to remain in contact with friends. There are no many social networks allowing people to contact with strangers except those on-line dating websites. Another drawback of Internet, especially those social networks, is it makes people spend too much of their time on their PCs or their phones. Food is life. Instead of connecting people in small screens, restaurants are the calling ground for friends and families alike, or even for strangers. However, restaurants cost money, and most people cannot afford for going restaurants every day or even every week. In order to attract people, some restaurants offer better deal. For example, Applebee's 2 for $20 allows you to get two salads or an appetizer, as well as two main meals with sides. The common trend is that people love casual entertaining. It makes meal sharing getting popular. People come to these events and meet people who have a shared love of food. Many meal sharing systems make eating with strangers easier than ever. In a generation where almost everyone has a Facebook, Twitter or Instagram account, it turns out meeting face-to-face over a shared meal is an enduring experienced. However, not everyone would like to host dinner at their home with strangers.

### SUMMARY OF THE INVENTION

It is, therefore, the objects of the present invention are intended to overcome the drawbacks of the conventional art.

Accordingly, an object of the present invention is to provide systems and methods for allowing people to share dinners' tables.

Another object of the present invention is to provide systems and methods for allowing people to share dinners' meals.

Another object of the present invention is to provide systems and methods for allowing people to arrange payments to their shared dinners.

Another object of the present invention is to provide systems and methods for allowing people to arrange their charitable donations at their dinners.

Another object of the present invention is to provide systems and methods for allowing people to reduce their cost of dining in restaurants.

Another object of the present invention is to provide systems and methods for allowing people to know each other by going to dinner, lunch or breakfast together.

Another object of the present invention is to provide systems and methods for allowing people to connect with strangers through social networks.

Another object of the present invention is to provide systems and methods for performing people search on Internet or social networks.

Another object of the present invention is to provide systems and methods for searching people over Internet or social networks to find out people to share meals and tables.

Another object of the present invention is to provide systems and methods for searching people for dinner, lunch or breakfast.

Another object of the present invention is to provide system and methods for searching people over Internet, social networks or mobile apps.

Further objects and advantages of present invention will become apparent from a consideration of the drawings and ensuring descriptions.

A meal table sharing system according to the present invention comprises:
a sharing mode unit for allowing a user to select one or many sharing modes;
a restaurant selecting unit for allowing the user to select a restaurant, date and time for a meal;
a table size unit for allowing the user to select a meal table size or the number of people for the meal;
an invitation unit for allowing the user to propose a meal sharing invitation based on the selected restaurant, date, time, sharing mode;
a dispatching unit for dispatching the invitation to guests;
an accept unit for allowing the guests to accept the invitation;
a confirmation unit for, based on the acceptance by the guests, making a reservation to hold a table at the restaurant, and sending a confirmation to the user and the guests.

A method of instant or real-time sharing a meal table according to the present invention comprises:
in response to a single action performed by a user on a mobile device,
obtaining the current location of the user;
finding or obtaining a guest and a restaurant nearby;
sending an invitation of sharing a meal table at the restaurant to the guest and waiting for the guest accepting the invitation;
in response to the guest accepting the invitation,
making reservation at the restaurant, and sending a confirmation to the user and the guest.

Further objects and advantages of our invention will become apparent from a consideration of the drawings and ensuring descriptions.

The present invention is described in the detail below, together with its further objectives, features, and advantages, in conjunction with the following drawings:

### BRIEF DESCRIPTION OF THE DRAWINGS

FIG. 1 is a block diagram of a system suitable for practicing various embodiments of the invention.

FIG. 2 is a block diagram showing the detail of the dispatching unit 107 in FIG. 1.

FIG. 3 is a block diagram showing the detail of the accepting unit 108 in FIG. 1.

FIG. 4 is a flow diagram illustrating a method of sharing table and meal according to the present invention.

FIG. 5 is a flow diagram illustrating another method of sharing table and meal according to the present invention.

FIG. 6 is a block diagram showing people search system according to the present invention.

FIG. 7 is flow diagram illustrating a method of searching people according to the present invention.

### DETAILED DESCRIPTION OF THE INVENTION

Reference will now be made in detail to the preferred embodiments of the present invention, a method and system of sharing a meal table, examples of which are illustrated in the accompanying drawings.

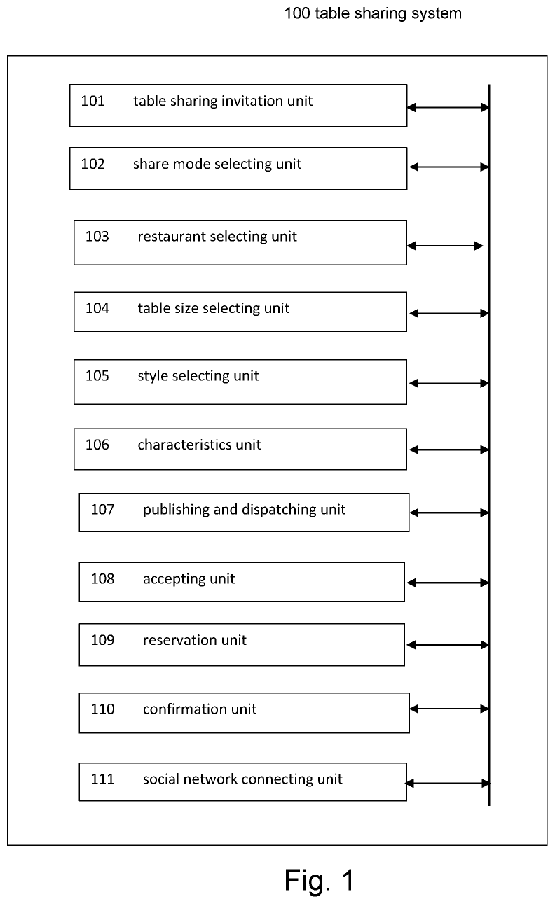

Referring now to the drawings, FIG. 1 shows a restaurant table sharing system in accordance with the present invention. In this example, a restaurant table sharing system 100 comprises a table sharing invitation unit 101, a share mode selecting unit 102, restaurant selecting unit 103, a table size selecting unit 104, a style selecting unit 105, a characteristics unit 106, a publishing and dispatching unit 107, an accepting unit 108, a reservation unit 109, a confirmation unit 110, and a social network connecting unit 111.

The restaurant table sharing invitation unit 101 allows a user to create an invitation to invite one or many guests or invitees, who may not know each other, to go out to a restaurant, and to sit at a table or in a private room for dinner, lunch or breakfast. The share mode selecting unit 102 allows the user to select one or many share modes or methods, which include sharing a table, sharing meals, sharing bills, splitting bills, or their combinations, such as sharing a restaurant table with one or many guests only, sharing a restaurant table and meals with one or many guests, or sharing a restaurant table, meals and bills with one or many guests. In the sharing table only mode, the user will share a dinner table with the one or many guests, the user and the guests order their own food, and each party pay for themselves individually. In the sharing table and meals mode, the user and the guests sit at a single table, order their meals, and share their meals. In the sharing table, meals and bills mode, the users and the guests sit at a single table in a restaurant, and they share meals and bills or split bills. Of course, other the share modes or methods can be applied. For example, a user shares a dinner table and dinner meals with one or many guests, and the user pays the bill for the one or many guests, or the one or many guests pay the bill for the user and the guests. The restaurant selecting unit 103 allows the user to select or propose one or many restaurants, and date and time of dining. The restaurant selecting unit 103 will, based on the best or better prices from one or many restaurants for the number of the people who join for dinner, propose one or many restaurants. For example, a user invites one guest to have a dinner. The restaurant 103 finds Applebee's 2 for $20 is the best price deal, and proposes Applebee's for the dinner. In the invitation, the user may select one or many restaurants through the restaurant selecting unit 103 based on locations or restaurants' types. The restaurants' types are Italian food, Chinese food, Korean Food, steak, sea food, and etc. The table size selecting unit 104 allows the user to select or indicate the maximum number of seats at the table. For example, if the user selects the maximum number of seats is 6, he expects 6 people, including the guests and the user, will go out to eat together. The style selecting unit 105 allows the user to select or indicate one or many styles of the dinner, lunch or breakfast in the invitation. The styles can be sports, a romantic dating or a professional lunch. The guests' characteristics selecting unit 106 allows the user to select or input one or many characteristics for the user expected guests and set up his own characteristics or other parameters. The characteristics or parameters can be gender, age, race, education, profession, music, sports, and etc. Based on the user selected or indicated criteria through the share mode selecting unit 102, the restaurant selecting unit 103, the table size selecting unit 104, the style selecting unit 105 and the characteristics unit 106, the publishing and dispatching unit 107 publishes the invitation to one or many websites, one or many social networks, or mobile apps, or dispatches the invitation to one or many targeted guests, whose characteristics match the user's selected or requested characteristics, through emails, messages, mobile apps or social networks. The accept unit 108 allows the guests to accept the invitation. The reservation unit 109, based on the acceptance of the guests, makes a reservation in the selected restaurant. The reservation can be done by sending a reservation request directly to the restaurant's system, or sending the reservation request to a third-party reservation system, such as OpenTable. The confirmation unit 110 sends confirmation notices to the user and the guests after receiving the restaurant's reservation confirmation. The social network connecting unit 111 connects the user and the guests with each other through mobile apps, email, chat tools, or social network for allowing the user and guests to know each other and communicate with each other. The social network connecting unit 111 allows the user to set a temporary group in their popular social networks, such as FACEBOOK or WECHAT for allowing the user and guests to know each other and communicate with each other easily. The social network connecting unit 111 automatically sets a temporary group in their popular social networks, such as FACEBOOK or WECHAT for allowing the user and guests to know each other and communicate with each other easily.

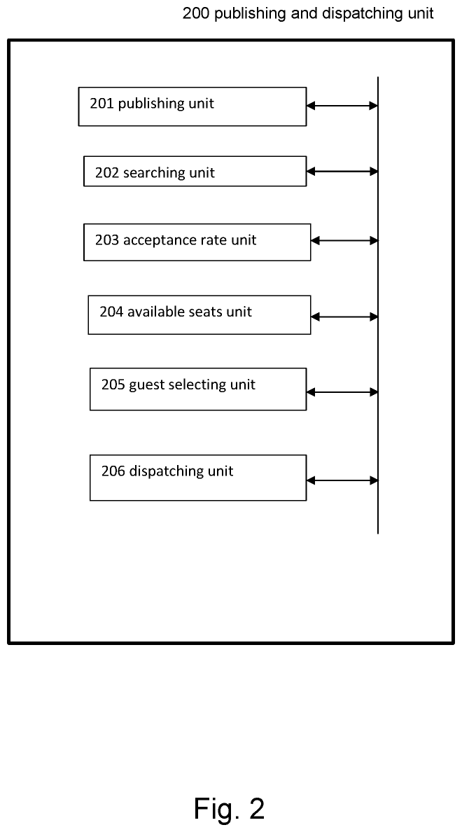

FIG. 2 shows the publishing and dispatching unit 107 in detail according to the present invention. In FIG. 2, the publishing and dispatching unit 200 (107 in FIG. 1) comprises a publishing unit 201, a searching unit 202, an acceptance rate unit 203, available seats unit 204, a guest selecting unit 205, and a dispatching unit 206.

The publishing unit 201 publishes the user's invitation into one or many websites, social networks, one or many mobile apps, and allows one or many viewers or guests to view the invitation and accept the invitation. The publishing unit 201 allows viewers or guests to select or input a particular share mode and lists the open invitations with the selected share mode. The searching unit 202 for identifying or obtaining one or many expected or prospected guests from one or many databases or social networks, based on the user selected or input guests' characteristics, the location of the restaurants, and the date and time for the dinner, lunch or breakfast. The can be done by using big data or artificial intelligence (AI) technology. The acceptance rate unit 203 determines or estimates an acceptance rate for the invitation. The invitation acceptance rate can be calculated by using big history data, machine learning and other artificial intelligence (AI) technologies. The available seats unit 204 calculates the available seats based on the maximum number of seats at the table and the number of the guests who have already accepted the invitation. The guest selecting unit 205 selects one or many guests from the expected or prospected guests. The number of the selected guests or candidates are based on calculated the available seats and the determined acceptance rate. For example, if the current available seats are A=10 and the determined acceptance rate is R=10%, the number guests, who will receive the invitation, will be N=A/R=10/0.10=100. In use, there may be a tolerance here. In another word, the N may be 110 or 120. It all depends on the tolerance factors set in systems. The dispatch unit 206 sends the invitation to each of the selected guests. For example, it sends the invitation to the selected guests through emails, messages, mobile apps or other social networks. In this case, it will make sure that the invitation is still valid (there is still an available seat for the dinner) when the guests read the email or message and accept the invitation.

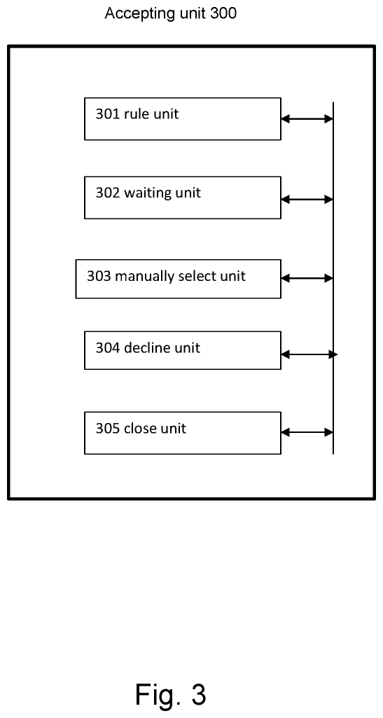

FIG. 3 shows the accept unit 108 in detail according to the present invention. In FIG. 3, the publishing and dispatching unit 300 (108 in FIG. 1) comprises a rule unit 301, a waiting unit 302, a manually accept unit 303, a decline unit 304 and a close unit 305.

The rule unit 301 allows the user to set one or many rules to decline guests. For example, set a rule to decline guests after reaching the max amount of “accepts” for the dinner invitation. The rule unit 301 also allows the user to set manually acceptance. In this case, all the guests who accepted the invitation will be in a waiting list for waiting the user's selection. The user views the guests from the waiting list, reviews the guests' information and select the guests to be accepted.

The publishing unit 201 further comprises a displaying unit and a visual unit. The displaying unit displays or lists one or many open invitations ordered by one or many users who created the one or many invitations, by one or many guests who accepted the invitations, or by the share modes which are specified in the invitations. It also can display the open invitations by a particular selected share mode. The share modes could be sharing a restaurant table with one or many guests only, sharing a restaurant table and meals with one or many guests, or sharing a restaurant table, meals and bills with one or many guests. In the sharing table only mode, the user will share a dinner table with the one or many guests, the user and the guests order their own food, and each party pay for themselves individually. In the sharing table and meals mode, the user and the guests sit at a single table, order their meals, and share their meals. In the sharing table, meals and bills mode, the users and the guests sit at a single table in a restaurant, and share meals and split the bill. Of course, other the share modes or methods can be applied. For example, the user shares a dinner table and the user pays the bill for the one or many guests, or the one or many guests pay the bill for the user. In another sharing mode example, the user shares a dinner table and dinner meals, and the user pays the bill for the one or many guests, or the one or many guests pay the bill for the user. The displaying unit allows to display the invitations of the sharing mode that the user will pay bills, or to display the invitations that the guests will pay bills. The visual unit generates or obtains one or many visual components for the one or many characteristics or the one or many dinner styles, and displays these visual components over, under or nearby the users' names, the guests' names, invitations' descriptions, or restaurants' names in the list page or screen. The visual unit also generates or obtains one or many visual components for those invitations matching the person's query criteria.

The table sharing system according to the present invention also comprises a bidding unit for allowing the user to send an invitation to one or many guests for bids for a dinner. The table sharing system according to the present invention further comprises a charity organization selecting unit for allowing guests to allow the user or the one or many guests to select one or many charity organizations to donate to.

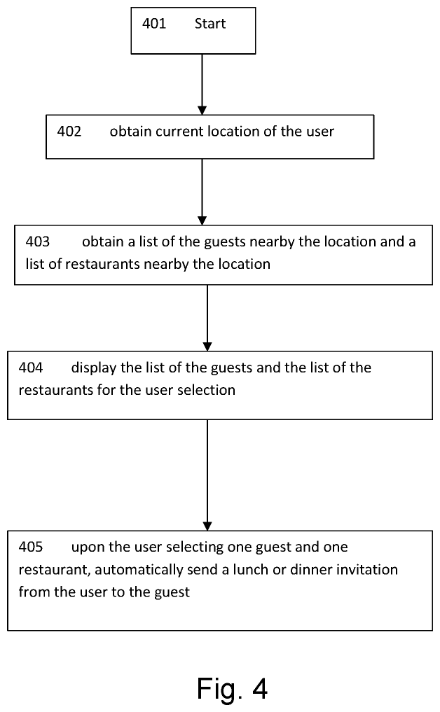

FIG. 4 shows a method of sharing table and meal according to the present invention. It starts at step 401, and obtains the current location of the user through his mobile device at the step 402. At the step 403, it obtains the one or many prospected guests nearby the user and one or many restaurants nearby the user, and at the step 404, it displays or lists the obtained prospected guests and the restaurants in user's mobile device. At the step 405, upon the user's selecting one guest and one restaurant, it automatically proposes a next meal, which is a lunch or dinner, invitation from the user to the guest, and send it to the selected guest. At the step 402, the prospected guests are obtained based on the match or similarity between the sharing table meal profile parameters or data of the user and the sharing table profile parameters or data of the prospected guests. The sharing table meal profile parameters or data comprise gender, age, preferred table sharing mode, culture, favorite food or restaurants, sports, music, movies, available time in their calendars. For example, a boy (the user) is looking for a girl, who is a 76er's fan, for a dinner at Penn Station of New York city after the game that the Sixers won over the Knicks. The system finds out and lists a couple girls and 2 Japanese restaurants which are good for the boy and the girls based on their sharing table meal profile parameters or data.

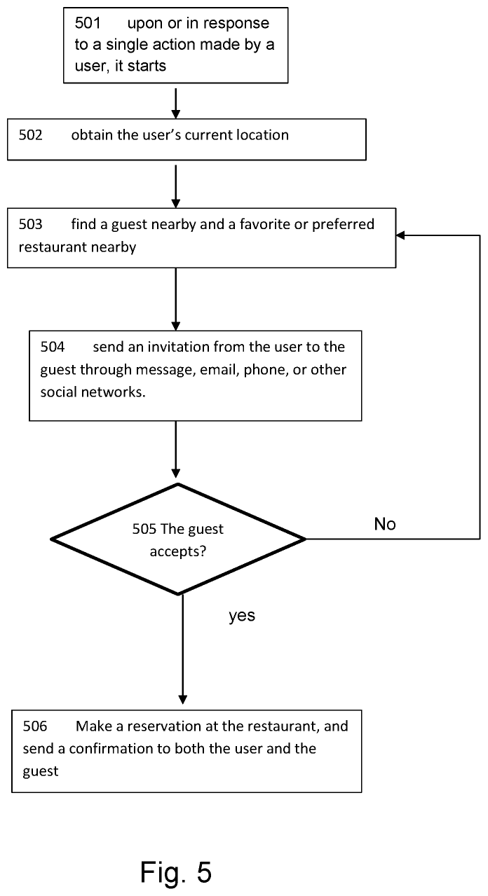

FIG. 5 shows another method of sharing table and meal according to the present invention. It starts at the step 501 upon or in response to only a single action being performed by a user. The single action could be pressing, clicking, touching or tapping a button or a virtual button on the users' mobile device screen or user's PC screen. The single action could also be the user's voice commends or a user's movement or gesture. At the step 502, the present embodiment obtains the user's current location. At the step 503, the present embodiment obtains or finds a guest nearby and a favorite or preferred restaurant nearby based on the match or similarity between the stored sharing table meal profile parameters or data of the user and the sharing table profile parameters or data of the guest. The sharing table meal profile parameters or data comprises gender, age, preferred table sharing mode, culture, favorite food or restaurants, sports, music, movies, available time in their calendars. The sharing table meal profile parameters or data also comprise gender, age, culture and other characteristics of the expected dinner or lunch partners.

In another example of the present invention, before or at the step 503, it further includes another step of obtaining the current open invitations with the same location area and the same time period, and accepts one of the invitations if its required characteristics match the characteristics of the user, and jumps to the step 506.

In another example of the present invention, at 503, it finds one or many prospected guests base on based on the match or similarity between the stored sharing table meal profile parameters or data of the user and the sharing table profile parameters or data of the prospected guests, obtains a face beauty scores for each prospected guests, and select, from the prospected guests, select a guest who has highest face beauty score among the prospected guests.

At the step 504, it may further include the step of sending the invitation to other social networks, such as FACEBOOK, WECHAT, and GOOGLE, and request these social networks to pass or forward the invitation to one or many their users or customers whose characters match the user's characters and the user's expected characters, receive the acceptances from their users or customers.

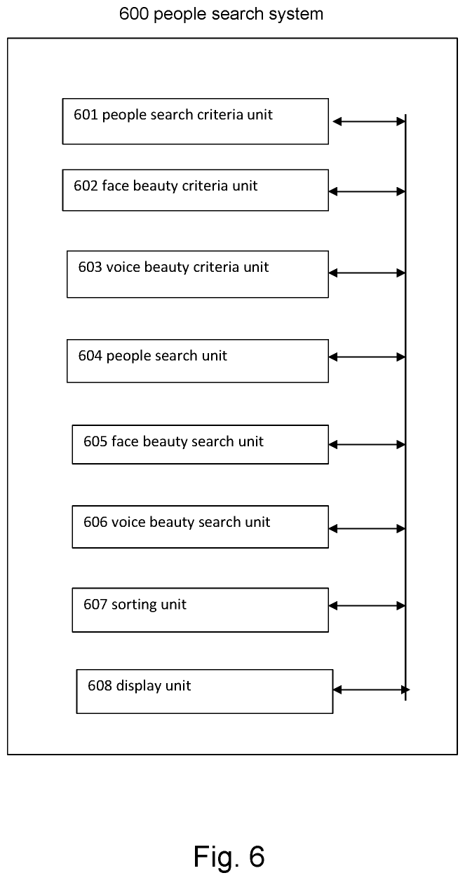

FIG. 6 shows a people searching system according to the present invention. People search system 600 comprises a people search criteria unit 601 for allowing a user to input criteria for searching people for sharing dinner, or for chatting, dating, making new friends or other purpose; a face beauty criteria unit 602 for allowing the user to input face beauty criteria for searching people; a voice beauty criteria unit 603 for allowing the user to input voice beauty criteria for searching people; a people search unit 604 for performing a people search, based on the people search criteria, over one or many databases or one or many search engines, and generating a list of results that are returned from the people search; a face beauty search unit 605 for searching or obtaining face beauty scores for the people in the list of the results; a voice beauty search unit 606 for searching or obtaining voice beauty scores for the people in the result list; a sorting unit 607 for sorting the results by their face beauty scores or by their voice beauty scores; and a display unit 608 for displaying the search results ordered by their face beauty scores or by their voice beauty scores.

The face beauty search unit 605 further comprises a face beauty analysis unit for scanning one or many pictures or images to obtain face data, such as face size or width, normal forehead size, nose size, mouth size, face symmetry, and etc., and to generate scores for face pictures or images. The voice beauty unit 606 further comprises a voice analysis unit for collecting voices and scores for the voices based on predefined standards.

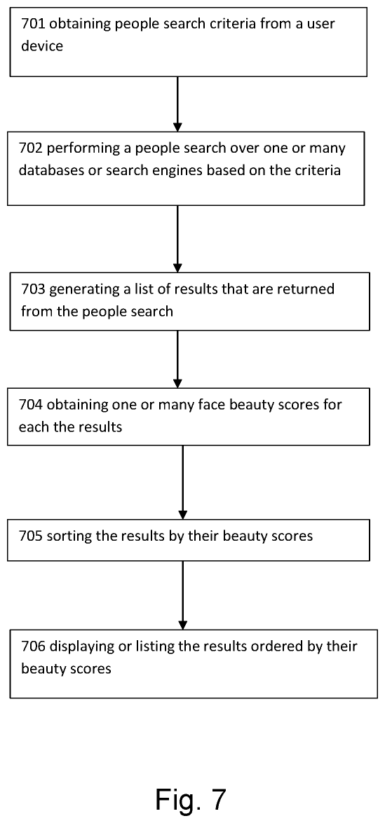

FIG. 7 illustrates a method of searching people over Internet, social networks, mobile apps or databases. At the step 701, the present embodiment receives or obtains people searching criteria from a user's device. At the step 702, the present embodiment, based on the searching criteria, performs a people search over one or many databases, one or many social networks, or one or many search engines. At step 703, the present embodiment generates a list of results that are returned from the performed people search. At the step 704, the present embodiment obtains one or many face beauty scores for each the results. At the step 705, the present embodiment sorts the list of the results in the order of the face beauty scores of the results. At the step 706, the present embodiment displays or lists the results ordered by face beauty scores of the results. The search results are one or many people whose characteristics match the user's searching criteria. For example, the present embodiment obtains a people search query that requests looking for Japanese girls who study in New York city, and the present embodiment performs a people search based on the query, and the search returns a list of 100 Japanese girls who are currently study in the colleges in New York city. The present embodiment, then, obtains a face beauty score for each of the 100 Japanese girl, sorts the list of the results by their face beauty scores in descending order, and displays the list in descending order of their face beauty scores. In another word, the present embodiment displays the matched Japanese with highest face beauty scores at the top of the list. Of course, it can sort the list in ascending order of their face beauty scores.

At the step 503 in FIG. 5, it further comprises obtaining the prospected guests' face beauty scores, and finding a guest or candidate among the prospected guests with the highest face beauty score. At the step 504, it sends an invitation from the user to the guest, who are the most beautiful or handsome among the prospected guests, through message, email, phone, or other social networks.

At the step 1 in FIG. 7, the people search criteria includes the user's preferred face beauty search categories, which are hot, sexy, sweet, gentle, smile, intelligent, classy, beautiful, softly sensuous, cute, cool, and etc. The people search criteria may also include face beauty judgement rules, which could be western judgment rules, Asia judgment rules, or African judgment rules, and etc. For a same person, different judgment rules will give him or her different face beauty scores. For example. Asia people consider small eyes are beautiful while western people like big eyes more. The face beauty judgement rules are geographical region rules, culture rules, age rules, and time rules. For example, by geographical region rules, one person may get different face beauty scores by applying Japan rules and France rules. Same thing, teens may have a different beauty standard than the older people. Also, the standard of beauty in 1960s is a little different than that of today.

The beauty judgement rules can also include similarity judgment rules, which generate face beauty scores based on the similarity between a test face and an entertainment or public star's face. For example, 70% of a test face A is similar to the face of Lady GaGa while 60% of a test face B is similar to the face of Lady GaGa. In this case, the embodiment of the present invention further includes obtaining user's input, indicated or selected an entertainment or public start, and at the step 704, the embodiment of the present invention obtains face beauty scores for each result (persons in the list) based on the similarity percentage between each result and the star's face. When the user selects star Lady GaGa's face as a beautiful sample face, face beauty score of the test face A is 70, and the face beauty score of the test face B is 60. The user inputs or selects one or many his or her face beauty categories or set his or her default face beauty categories in system. In this case, at the step 704, the present embodiment obtains one or many face beauty scores under the user input categories for each result. The user inputs or selects one or many his or her face beauty judgement rules or set his or her default face beauty judgement rules in system. In this case, at the step 740, the present embodiment obtains one or many face beauty scores by applying the user input face beauty judgement rules. The embodiment of the present invention also includes automatically sending an invitation to one or many persons, who have a higher face beauty scores, to join user's social networks such as Google, Facebook, WhatsApp, Viber, Twitter, YouTube, Instagram, Skype, WeChat, Weibo, Line, Wiki, etc. , or to join the user's chat or meeting room, based on the user's clicking a button on the result list, or other user's a single trigger action. The user's single action is a click on a button, a tap on the user's mobile device, a user's voice command, or a user's gesture.

The face beauty scores can be applied not only to searching people, but also to searching contents. For example, it allows to search contents on YouTube, Instagram, Twitter or TikTok, and sorts the search results list ordered by the face beauty scores of the creators of the contents.

The method in FIG. 7 further includes obtaining one or many the user uploaded pictures, comparing the pictures of each said result with the uploaded pictures and obtaining face beauty scores for each said result based on the similarity percentage between the pictures of said each result and the pictures uploaded by the user. For example, the user uploaded his own picture, and the user's people search criteria are movie stars. In this case, the search results will display the movie stars who and the user look alike. The result list is sorted by the similarity percentage (score) between the user and the results. The present embodiment may further include processing the uploaded picture. The processing may make the person younger or older, or may change persons' skin color or hair color, or may even make a face shape change. In this case, the present embodiment further includes timeline search. In this case, processing the user uploaded picture, and obtaining timeline. For example, 5 year later picture, 10 years later picture, 15 year later picture, and 20 year later picture. The embodiment of present invention will find, for each timeline picture, one or many results that have higher similarity percentage between the user's picture and the results, the embodiment of the present invention further includes displaying the list of the results in timeline mode or manner.

In FIG. 1, the system according to the present invention further includes a face beauty unit for allowing the user to select or input face beauty criteria; a face beauty score unit for obtaining face beauty scores for each prospected guests whose characteristics match the user's selected or requested characteristics; and a sorting unit for sorting the prospected guests by their face beauty scores, and sending the invitation the prospected guests ordered or sequenced by their face beauty scores. The dispatch unit dispatches the invitation to one or many targeted guests, whose characteristics match the user's selected or requested characteristics and with higher face beauty scores, through emails, messages or mobile apps. The system also includes a uploading unit for allowing the user to upload the face pictures or images of his expected guest; a face similarity unit for comparing the uploaded face picture or image with the faces of the prospected guests, and assign a face beauty score to each faces of the prospected guests based on the similarity between the uploaded pictures or images and the faces of the prospected guests; and a sorting unit for sorting the prospected guests by their face beauty scores. The dispatching unit will send invitation to the guests with higher face beauty scores first. The uploading unit also allows the user to upload his or her own pictures, and the face similarity unit compares the uploaded face pictures or images with the faces of the prospected guests, and assigns a face beauty scores to each faces of the prospected guests based on the similarity between the uploaded pictures and the faces of the prospected guests. In another word, the user and the expected guest look alike (couple face). The publishing unit lists one or many users and one or many guests of one or many open invitations ordered by the face beauty scores of the users and the guests. In another word, the publishing unit lists one or many open invitations in one or many websites, one or many social networks, or one or many mobile apps ordered by the face beauty scores of the users or creators who created the invitations. In the list generated by the publishing unit, it displays the name or descriptions of the open invitations, the name or IDs of the creators of the open invitations, the creators' pictures, and the creators' face beauty scores.

Although the invention has been described with reference to the above-described embodiments and examples, it will be appreciated that many other variations, modifications, and applications may be devised in accordance with the broad principles of the invention disclosed herein. The invention, including the described embodiments and examples and all related variations, modifications and applications is defined in the following claims.

Therefore, the forgoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

1. A meal table sharing system comprising:
a sharing mode unit for allowing a user to select one or many sharing modes;
a restaurant selecting unit for allowing the user to select a restaurant, date and time for a meal;
a table size unit for allowing the user to select a meal table size or the number or the maximum number of people for the meal;
an invitation unit for allowing the user to propose a meal sharing invitation based on the selected restaurant, date, time, sharing mode.

2. The meal table sharing system of claim 1 further comprising:
a dispatching unit for dispatching the invitation to one or many guests;
an accept unit for allowing the guests to accept the invitation.

3. The meal table sharing system of claim 2 wherein said share modes are sharing a restaurant table only; sharing a restaurant table and meals;
sharing a restaurant table, meals and bills; sharing a restaurant table, meals, and the paying bills by the user; and sharing a restaurant table and meals, and paying bills by the guests.

4. The meal table sharing system of claim 3 further comprising
a confirmation unit for, based on the acceptance by the guests, making a reservation to hold a table at the restaurant, and sending a confirmation to the user and the guests.

5. The meal table sharing system of claim 4 further comprising:
a characteristics or parameters unit for allowing the user to select or input one or many characteristics or parameters of the guests;
a search unit for identifying or obtaining one or many prospected guests from one or many databases or social networks, based on the user selected or input guests' characteristics or parameters, the location of the restaurants, and the date and time for the meal;
an acceptance rate unit for determining or estimating an acceptance rate for the invitation;
an available seats unit for obtaining the current available seats for the meal based on the maximum number of people for the meal and the number of the guests who have already accepted the invitation;
a guest selecting unit for selecting the one or many guests from the prospected guests based the acceptance rate of the invitation and the available seats of the meal; where said dispatching unit dispatches the invitation to the selected guests.

6. The meal table sharing system of claim 2 further comprising:
a face beauty unit for obtaining face beauty scores for one or many prospected guests;
a selecting unit for selecting the guests from the prospected guests based on the face beauty scores of the prospected guests; wherein the dispatching unit dispatches the invitation to the selected guests.

7. The meal table sharing system of claim 1 further comprising:
a publishing unit for publishing or listing one or many open invitations on one or many websites, social networks or mobile apps for allowing one or many viewers or prospected guests to view the open invitations;
a face beauty unit for obtaining one or many face beauty scores for the persons who create the open invitations; wherein said publishing unit lists the open invitations ordered by the face beauty scores of the creators of the open invitations.

8. The meal table sharing system of claim 7 further comprising:
a selecting or inputting unit for allowing the viewers or the prospected users to select a particular share mode, and listing or displaying the open invitations with the selected share mode; wherein said share modes are sharing a restaurant table only; sharing a restaurant table and meals;
sharing a restaurant table, meals and bills; sharing a restaurant table, meals, and the paying bills by the user; and sharing a restaurant table and meals, and paying bills by the guests.

9. The meal sharing system of claim 7 wherein the publishing unit lists the open invitations which includes the names or the descriptions of the open invitations, the names or IDs of the creators of the open invitations, the pictures of the creators and the face beauty scores of the creators.

10. A method of sharing a meal table, the method operating within a meal table sharing management system and comprising:
in response to a single action performed by a user on a mobile device, obtaining the current location of the user;
finding or searching out a guest and a restaurant nearby the user;
sending an invitation of sharing a meal table at the restaurant to the guest.

11. The method of claim 10 further comprising:
waiting for the guest accepting the invitation; and in response to the guest accepting the invitation,
making reservation at the restaurant, and sending a confirmation to the user and the guest.

12. The method of claim 10 further comprising:
obtaining one or many the user's parameters, and based on the parameters and the current user's location to find a guest who is current nearby the user's location and whose characteristics match the user's parameters, and a restaurant nearby.

13. The method of claim 12 further comprising:
finding one or many prospected guests who are current nearby the user's location and whose characteristics match the user's parameters;
obtaining one or many face beauty scores of said each prospected guest;
selecting, from the prospected guests, a guest who has the highest face beauty score among the prospected guests; wherein the single action could be pressing, clicking, touching or tapping a button or a virtual button on the users' mobile device screen, the user's voice commends, or a user's movement or gesture.

14. A method of searching people over Internet, social networks, mobile apps or databases, the method operating within a people searching engine or system and comprising:
receiving or obtaining people searching criteria from a user's device;
performing a people search over one or many databases, one or many social networks, or one or many search engines, or one or many mobile apps, based on the searching criteria;
generating a list of results that are returned from the performed people search;
obtaining one or many face beauty scores for each said results;
sorting or ordering the list of the results by the face beauty scores of the results;
displaying the list of the results ordered by the faces beauty scores.

15. The method of claim 14 further comprising:
receiving or obtaining the user input or default face beauty categories;
obtaining one or many face beauty scores under the obtained face beauty categories for each said result.

16. The method of claim 15 further comprising:
receiving or obtaining the user input or default face beauty judgement rules;
obtaining one or many face beauty scores for each said result by applying the face beauty judgement rules.

17. The method of claim 14 further comprising:
receiving or obtaining the user input or selected an entertainment or public start;
obtaining one or many face beauty scores for said each result based on the similarity percentage between the face of said each result and the star's face.

18. The method of claim 14 further comprising:
obtaining one or many the user uploaded pictures;
comparing the pictures of each said result with the uploaded pictures;
obtaining face beauty scores for each said result based on the similarity percentage between the pictures of said each result and the pictures uploaded by the user.

19. The method of claim 14, further comprising:
sending an invitation to one or many persons, who have a higher face beauty scores, to join user's social networks such as Google, Facebook, WhatsApp, Viber, Twitter, YouTube, Instagram, Skype, WeChat, Weibo, Line, Wiki, or to join the user's chat or meeting room, based on the user's a single trigger action; and wherein
the user's single action is a clicking a button on the list of results, a tapping on the user's mobile device, a user's voice command, or a user's gesture;
the sorting by face beauty scores is in descending order;
the results include names and face beauty scores;
said face beauty categories are hot, sexy, sweet, gentle, smile, intelligent, classy, beautiful, softly sensuous, cute, cool; and
said face beauty judgement rules are geographical region rules, culture rules, age rules, and time rules.

20. The method of 18 further including:
processing the user uploaded pictures comparing the pictures of each said result with the uploaded and processed pictures;
obtaining face beauty scores for each said result based on the similarity percentage between the pictures of said each result and the user uploaded and processed pictures.
